(19) United States
(12) Patent Application Publication
(10) Pub. No.: US 2025/0205574 A1
(43) Pub. Date: Jun. 26, 2025

(54) INTERACTIVE GAME VIRTUALIZATION AND PRACTICING SYSTEM, AND GAME PRACTICING METHOD USING THE SAME.

(71) Applicant: Benjamin Dolgin-Gardner, Montreal (CA)

(72) Inventor: Benjamin Dolgin-Gardner, Montreal (CA)

(73) Assignee: Hatch Manufacturing Limited, Baldwin County, MD (US)

(21) Appl. No.: 18/395,636

(22) Filed: Dec. 25, 2023

(51) Int. Cl. A63B 69/00; A63B 63/00; A63B 71/06

(52) U.S. Cl. CPC A63B 69/0026; A63B 63/004; A63B 71/0669; A63B 2225/54; A63B 2225/74

(57) ABSTRACT

An interactive game virtualization and practicing system is disclosed. The system comprises one or more interactive passing devices and one or more interactive goal targets. Wherein, each of the goal targets and passing devices includes electronic components such as a Bluetooth microcontroller unit, a light, sensors, a battery and a printed circuit board. The system also includes a support structure, wherein the goal targets are attached to the support structure. The system further includes a propelling device, a puck and a software application of a user device, wherein the software application serves as the control center for the system, wherein the system components are configured to perform the method of practicing a sports game.

### FIELD AND BACKGROUND OF THE INVENTION

The present invention relates to an interactive game system and more particularly relates to an interactive game virtualization and practicing system, and a game practicing method using the same.

### BACKGROUND OF THE INVENTION

An ice hockey player needs to have outstanding puck passing, receiving, and shooting skills to perform most effectively. Rebound passing devices (‘passers’) are a common training tool that hockey players use while practicing their ice hockey skills. By enhancing their focus, anticipation, shot/pass timing, and other skills, the passers assist players in developing their passing and receiving abilities. Passers of various designs offer both on- and off-ice training. Such passers have built-in puck-rebounding components that are generally composed of steel, plastic, or wood. They also come in a variety of shapes, including square, rectangle, and triangle. Elastic bands or hard foam are frequently used as the materials which the pucks rebound off. They provide an elastic effect that causes the puck to bounce back to the player.

Another tool used for ice hockey training is goal targets. The goal targets are typically hung from the front of a hockey goal post. Players shoot at the goal targets to improve their shot's accuracy. There are goal targets that include interactive electronics. Lights are installed in these goal targets that illuminate to show the player where to aim the puck. When the illuminated goal target is hit by the puck or after a given amount of time elapses when it is not, the light switches from one goal target to another.

A common skill that hockey players practice is the quick release of a shot from an incoming pass. This could happen in the form of a ‘one timer’ where the player immediately shoots the incoming pass. The player could also receive the pass and shoot it towards the goal as quickly and accurately as possible. While interactive goal targets currently exist, interactive passers do not exist. Therefore, when passing the puck or shooting it, the goal targets and passers have no interaction with one another. If interactive passers existed and could communicate with interactive goal targets, then it would be possible to create a game which integrates passing and shooting.

The drawbacks of the existing systems are as follows:

Although hockey practicing systems exist with interactive goal targets and different game modes, no system that combines passing with shooting at passers and goal targets, respectively.

There is no hockey practicing system that includes a software application, either on an external device or embedded in the electronics of passers or goal targets, to control lights of both goal targets and passers.

Since no systems exist that include passers and goal targets, no option exists to record the scores and thus player scoring data cannot be monitored or saved.

As a result, systems and methods for practicing games are required so that players can engage in interactive gameplay.

### BRIEF SUMMARY OF THE INVENTION

It is an object of the present invention to provide a multi-discipline interactive game virtualization and practice system for ice hockey.

It is another object of the present invention to create a system for playing interactive games that can transition between different game modes using a software application.

It is a further object of the present invention to allow a player to practice ice hockey with or without a software application.

It is a further object of the present invention to allow a player to practice ice-hockey using a software application without a passing device.

It is another object of the present invention to provide a game practicing system that enables players to practice passing the puck and improve the puck passing skills while providing an interactive gaming system.

### BRIEF DESCRIPTION OF DRAWINGS

The present invention will become clearly understood to those of ordinary skill in the art when descriptions of exemplary embodiments thereof are read with reference to the accompanying drawings.

FIG. 1 is a schematic view of the interactive game virtualization and practicing system according to an embodiment of the invention.

FIG. 2 is a flow diagram illustrating a method of practicing a sports game, using the interactive game virtualization and practicing system of FIG. 1.

FIG. 3A is a schematic view of a passing device comprising the electronic components.

FIG. 3B is a schematic view of the passing device of FIG. 3A and a puck passing towards the passing device.

FIG. 3C is a schematic view of the passing device of FIG. 3A and the puck hitting the passing device.

FIG. 3D is a schematic view of the passing device of FIG. 3A and the puck rebound by the passing device.

FIG. 4A is a schematic view of the system of FIG. 1 with a software application displaying electronics on the user interface.

FIG. 4B is a schematic view of the system of FIG. 1 with the software application displaying electronics being segregated into goal targets or passers by the player.

FIG. 4C is a schematic view of the system of FIG. 1 with the software application displaying electronics segregated into two groups.

### DETAILED DESCRIPTION OF THE INVENTION

The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention. For a more complete understanding of the present invention, reference is now made to the following descriptions taken in conjunction with the accompanying drawings.

According to an embodiment of the present invention, a method of practicing a sports game using an interactive game virtualization and practicing system is disclosed. The method also includes launching a software application on the user interface of a mobile device, wherein the software application serves as the control center for the interactive game virtualization and practicing system. The method includes turning on electronics connected to one or more interactive goal target(s) and one or more interactive passing device(s). The method further includes connecting the software application, via Bluetooth, with the goal targets and passing devices. The method also includes selecting, by the player, a game mode on the software application. The method includes segregating, on the user interface of the software application, the goal targets and passing devices into two groups in order to distinguish the goal targets and passing devices. The method further includes turning on, by the software application, via Bluetooth, the light of one of the passing devices to illuminate. The method includes passing, by the player, a propelling device, the puck, to hit the light-illuminating passing device, wherein, upon the puck hitting the passing device: alerting, via Bluetooth, the software application of the hit by triggering a notification to the software application and rebounding the puck, by the passing device, to the player. The method also includes triggering the software application to turn on the light of one of the goal targets to illuminate. The method further includes shooting, by the player, at the light-illuminating goal target. The method includes determining whether the puck successfully hits the illuminated goal target. The method also includes turning off the light of the goal target and recording, in the software application, the score of the player, if the goal target is hit by the puck. The method also includes turning off the light of the illuminating goal target, if the goal target is not hit by the puck within preset time. The method further includes repeating steps from turning on the light of the passing device to turning off the light of the illuminated goal target until the puck hits the illuminating goal target at preset times.

According to an embodiment of the present invention, an interactive game virtualization and practicing system is disclosed. The system comprises one or more interactive passing device(s), one or more interactive goal target(s), wherein each of the goal targets and passing devices includes electronic components such as a Bluetooth microcontroller unit (MCU), a light, one or more sensors, a battery and a printed circuit board (PCB). The system also includes a support structure, wherein the goal targets are attached to the support structure. The system further includes a propelling device, like a hockey stick, a propelled object, like a puck, and a software application, wherein the software application serves as the control center for the system, wherein the system components are configured to perform the method of practicing a sports game.

The present invention discloses an interactive game virtualization and practicing system that comprises interactive passing devices and interactive goal targets including electronics components. In some embodiments, the aforementioned system is also referred to as “a game system,” “a gaming system,” “a game playing system,” “a game practicing system,” “a game training system,” “an interactive game system,” “an interactive game playing system,” “an interactive training system,” “a hockey practicing system,” “a hockey training system,” “an ice hockey practicing system,” “an hockey training system” or “a system.” The electronic components can be integrated in any type of passing devices. In various aspects of the invention, the electronic components are also referred to as “electronics.” The key electronic components of the system include an illuminating element that are attached to the passing devices and goal targets, and indicate a player where to pass or shoot the puck and sensors attached to the passing devices and goal targets that sense the impact by a puck. In short, the illumination indicates where to pass or shoot and the one or more sensors determine if the pass or shot was accurate. This makes the system interactive.

In one implementation, the software application communicates with the electronic components of the passing devices and goal targets by sending and receiving commands. In some aspects, the software application is also referred to as “a mobile application,” or “an application.” The commands include turning on or off the lights, changing colors of the lights, and changing light flashing patterns. According to another embodiment, the user interface of the software application includes options to select game modes, display scoreboard, game results, and electronics settings configuration. Electronics settings include adjusting sensitivity of the one or more sensors, and connecting the electronics of the goal targets and passing devices to the software application.

In a preferred embodiment, the electronics components include a Bluetooth microcontroller unit (MCU), lights, one or more sensors, battery, and printed circuit board (PCB). In some embodiments, the Bluetooth MCU is also referred to as “a Bluetooth,” “a Bluetooth communication system,” “a Bluetooth low energy (BLE) module.” In one embodiment, the lights include LED lights. The Bluetooth MCU controls the system and has an embedded memory that stores the firmware for the electronic components. Bluetooth communicates wirelessly with the software program or directly with the electronic components of each passing device and goal target. According to one aspect of the invention, the player can opt to play the game with or without the software application. When played without the software application, the games are controlled by the firmware of the Bluetooth MCU. The lights indicate the passing devices and the goal targets that must be hit. The sensors detect when there is an impact by the puck. The sensors are calibrated based on the puck weight and typical travel speeds for hitting and passing. The objective of the game is to hit a specific number of times the illuminating goal target as quickly as possible. In various aspects of the invention, the term goal target is also referred to as “a shooting goal target,” or “a goal target.” For instance, if the player hits 5 goal targets, the game ends; hence, the score of the game is the total time that passed before the 5th goal target is hit.

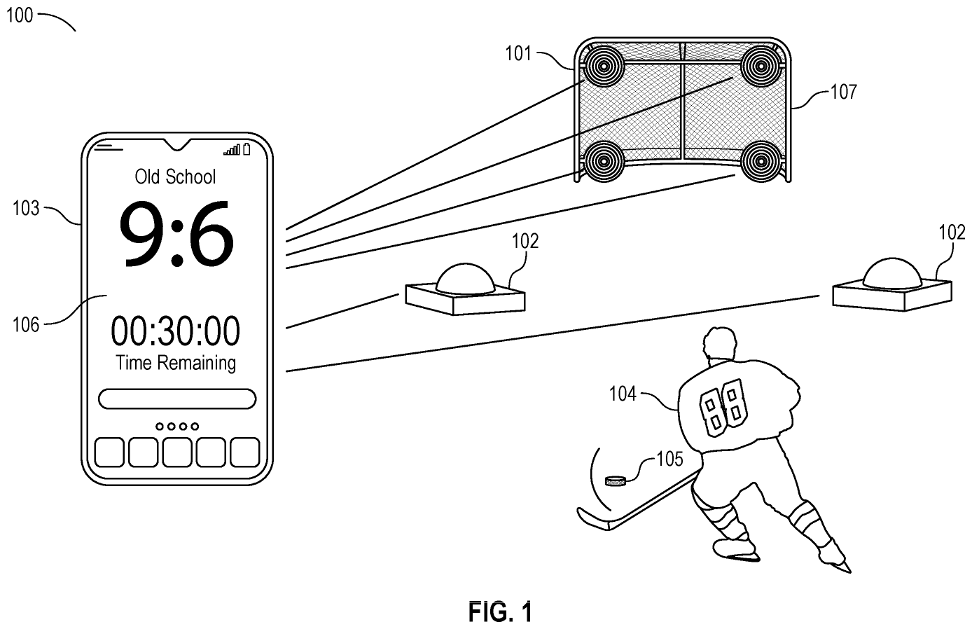

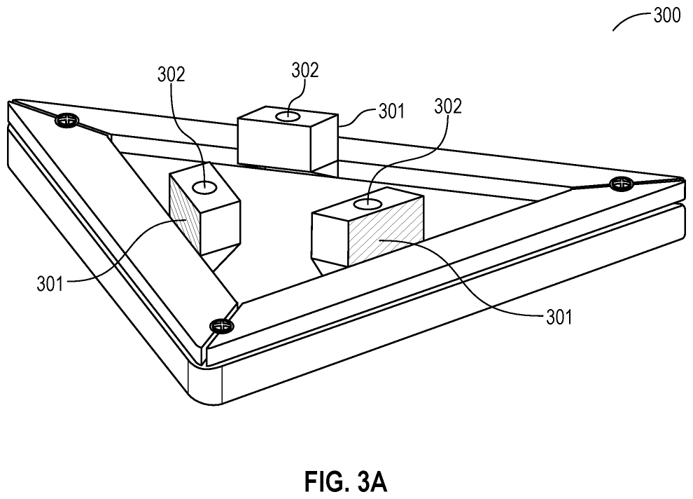

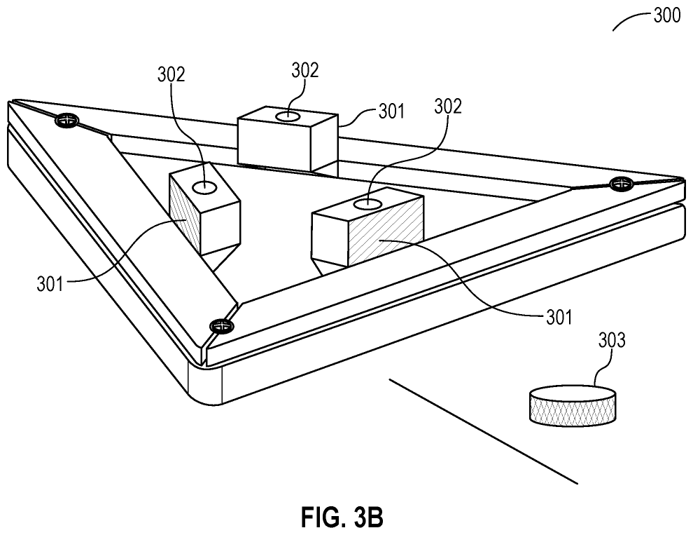

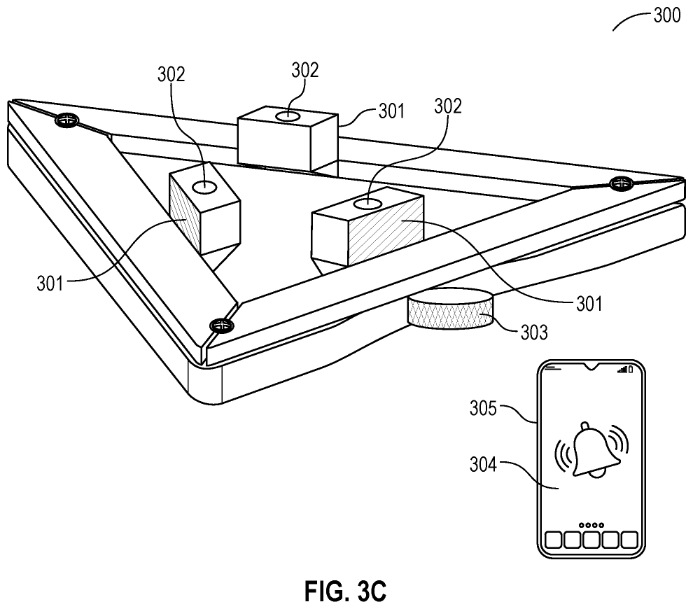

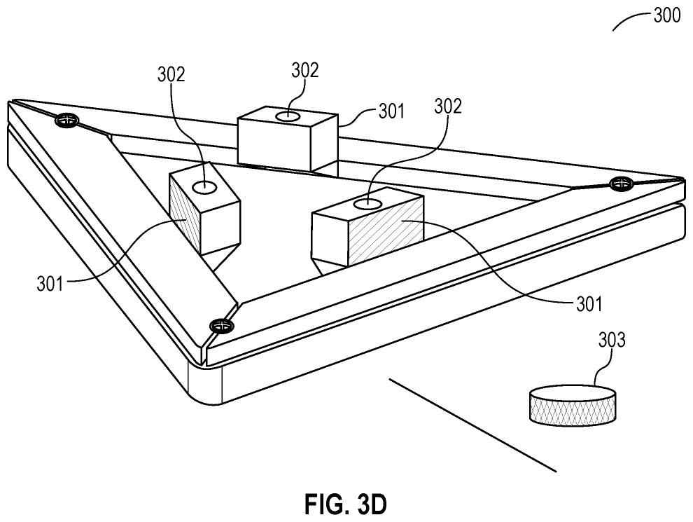

An interactive game virtualization and practicing system 100 as shown in FIG. 1 is disclosed according to an embodiment of the invention. The system 100 includes one or more interactive passing devices 102, one or more interactive goal targets 101. The passing devices are positioned on the ground and the goal targets 101 are attached to a support structure by a connecting mechanism such as a rope, wherein the support structure includes a goal post or similar structure that supports the goal targets. Each of the goal targets 101 and passing devices 102 includes electronic components such as a Bluetooth microcontroller unit (MCU), an LED light, one or more sensors, a battery and a printed circuit board (PCB). FIG. 3A depicts the components of a passing device 300 which includes a light 301 and one or more sensors 302. The light 301 and the one or more sensors 302 are connected with Bluetooth which is configured to enable wireless communication between the electronics and the software application. The light 301 is connected to and is capable of being activated by a light control system. The one or more sensors 302 are connected to and is capable of being activated by a sensor control system when the passing device 300 or goal target 101 is hit by the puck 105, 303. In various embodiments, the one or more sensors 302 include, but not limited to, an impact sensor, an infrared sensor, a motion sensor, a position sensor, a proximity sensor, a vibration sensor or any other sensor that senses the physical contact of an object. The one or more sensors 302 are calibrated to sense the impact or movement of the puck 105, 303 based on the weight, size, and typical travel speeds of the puck 105, 303. In one embodiment, the light control system and the sensor control system are connected to the Bluetooth communication system.

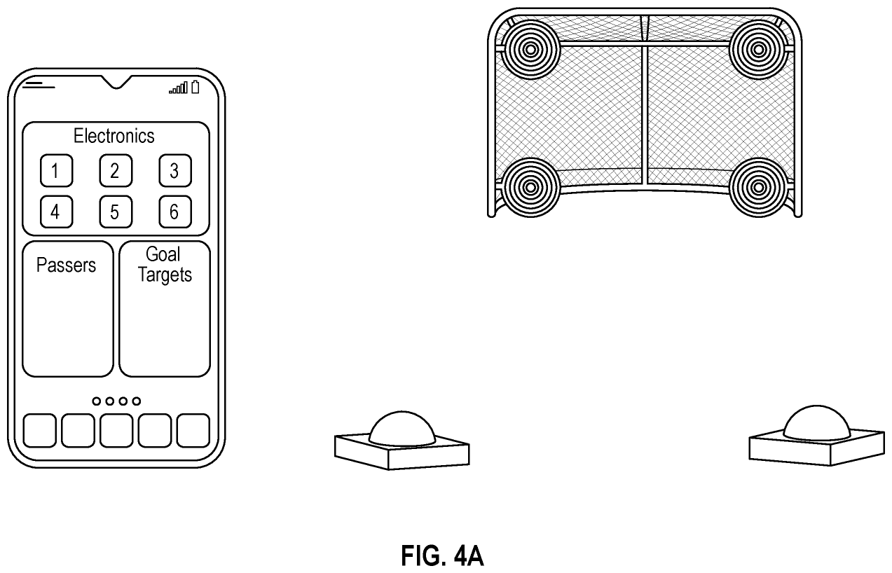

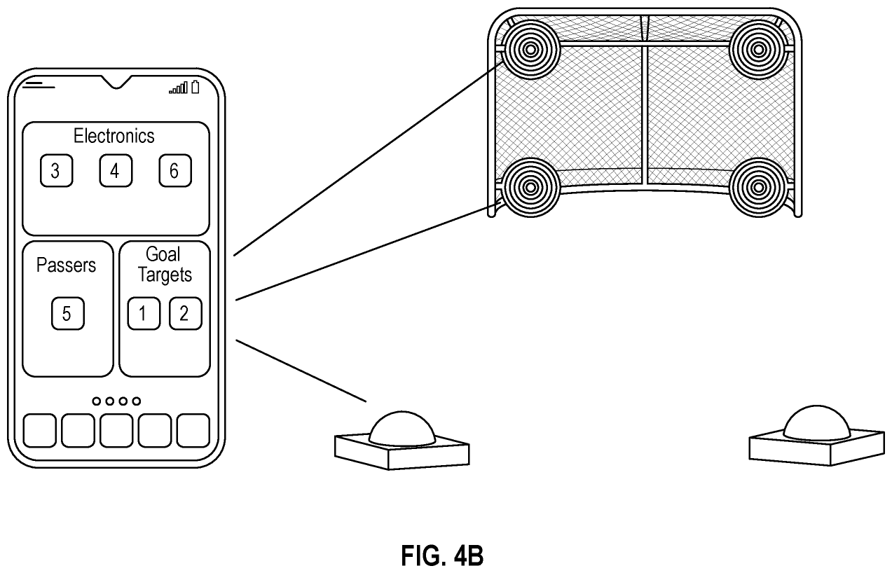

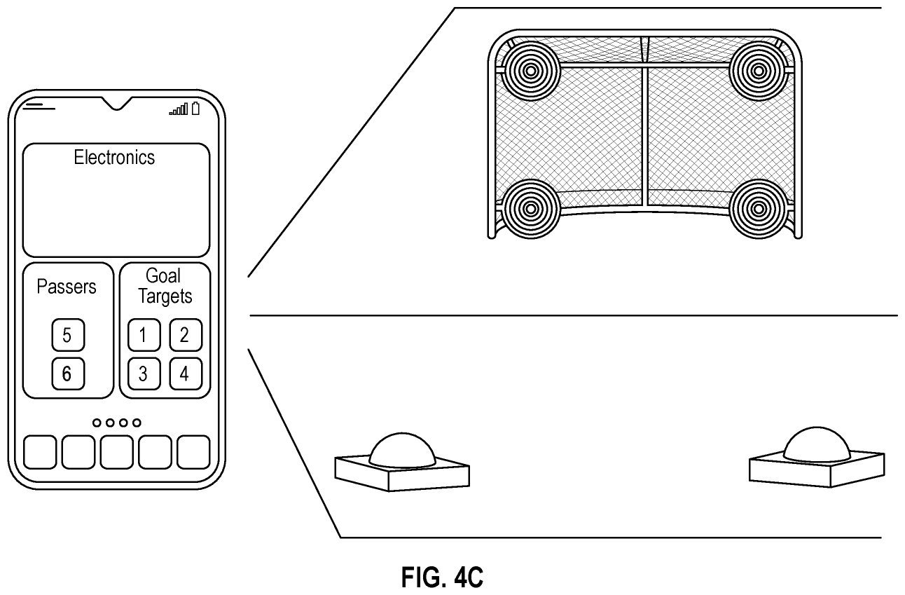

According to an embodiment, the system further includes a software application 106, 304 of a user device 103, 305, wherein the software application 106, 304 serves as the control center for the system. The user device includes a smartphone, laptop, tablet, personal computer, wearable mobile devices, workstation and the like. The user device each includes its own operating system, CPU, memory and storage, wherein the operating system includes Android, IOS, Microsoft Windows and the like. The user interface of the software application 106, 304 includes options for selecting game modes, displaying scoring, game results, and configuring the electronics settings. In one embodiment, the electronics settings include adjusting sensitivity of the one or more sensors 302 and connecting the electronics to the software application 106, 304. In one aspect of the present embodiment, a player launches the software application on the user interface of the user device. Then, the player turns on the goal targets and interactive passing devices. In one embodiment, the software application is connected, via Bluetooth, to the goal targets and passing devices. In one aspect, the electronic components are configured to wirelessly communicate with each other or with the software application via Bluetooth, allowing the game to be played with or without the software application. In one aspect, the game can be played without the software application 106, 304 on the user device 103, 305, but with the software application 106, 304 that is embedded in the MCU of the electronics. In one aspect, the player selects a game mode on the software application. As illustrated in FIGS. 4B and 4C, the goal targets and passing devices are segregated into two groups on the user interface of the software application in order to distinguish the goal targets and passing devices, and to send commands to respective passing devices and goal targets that need to receive the pass and hit, wherein the commands include turning on and off the LED lights, turning on user-preferred colors, and light flashing patterns. The player initially segregates or categorizes the electronics, as passers or goal targets, in the software application based on their Bluetooth addresses. Once this segregation is done, the software application is capable of recognizing and distinguishing between these devices in the future without the need for manual intervention.

In one specific aspect, the software application 106, 304 turns on the light 301 of one of the passing devices 300, via Bluetooth. The puck 105, 303 is then passed to hit the light-illuminating passing device, by the player using a propelling device. When the puck 105, 303 hits the passing device 300, the one or more sensors 302 recognize the hit, and alerts the software application 106, 304 by triggering a notification to the software application 106, 304 via Bluetooth. In various aspects, the one or more sensors 302 include, but not limited to, impact sensor, infrared sensor, motion sensor, position sensor, proximity sensor, vibration sensor or any other sensor that senses the physical contact of an object. The puck 105, 303 is then rebound, by the passing device 300, to the player. The software application 106, 304 is triggered to turn on the light 301 of a goal target 101 to illuminate, and the illuminating goal target is shot at by the player. The one or more sensors 302 are configured to determine whether the puck 105, 303 successfully hits the illuminated goal target, wherein the one or more sensors 302 are calibrated to sense the impact or movement of the puck 105, 303 based on the weight, size, and typical travel speeds of the puck 105, 303. Further, the sensitivity of the one or more sensors 302 are adjustable to accommodate different players who shoot and pass the puck 105, 303 at different speeds. The light 301 of the goal target 101 is turned off and the score of the player is recorded in the software application 106, 304, if the goal target 101 is hit by the puck 105, 303. The light 301 of the illuminating goal target is turned off, if the goal target 101 is not hit by the puck 105, 303 within a preset time. Steps from turning on the light 301 of the passing device 300 to turning off the light 301 of the illuminating goal target are repeated until the puck 105, 303 hits the illuminating goal target a preset number of times. In one aspect, the software application is also configured to display game updates including a score or game results on the user interface of the application to the player. In one embodiment, the software application 106, 304 includes a game mode selection module, Bluetooth connectivity module, an LED lighting control module, a sensor data acquisition module, scoring and statistics module, an electronic configuration module and a game rules module. The game mode selection module is configured to select a game mode for the goal targets 101 and the passing devices 300. The Bluetooth connectivity module is configured to establish a wireless connection between the application 106, 304 and the electronics, and transmits commands from the application 106, 304 to and from the electronics. The LED lighting control module is configured to control the LED lights on the passing devices 300 and the goal targets 101. The sensor data acquisition module is configured to collect the sensor data from passing devices 300 and goal targets 101. The scoring and statistics module is configured to calculate and display the score and other game statistics of the player. The electronics configuration module is configured to allow the player to check or control the device settings, such as sensor sensitivity, battery status, and connect the goal targets. The game rules module is provided with the rules and instructions of the game.

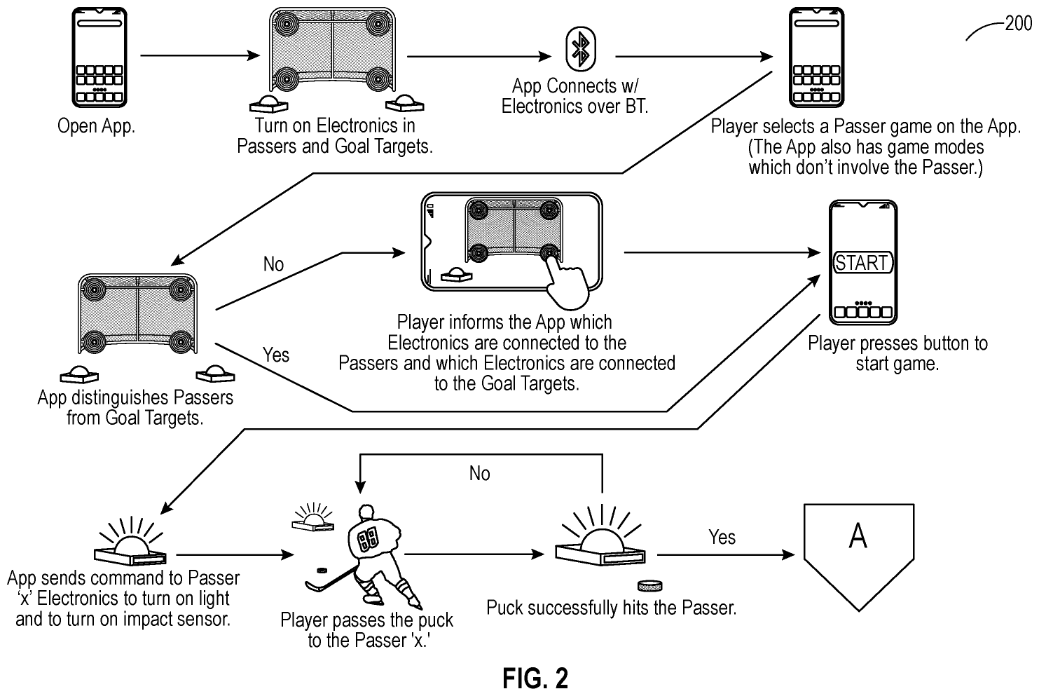

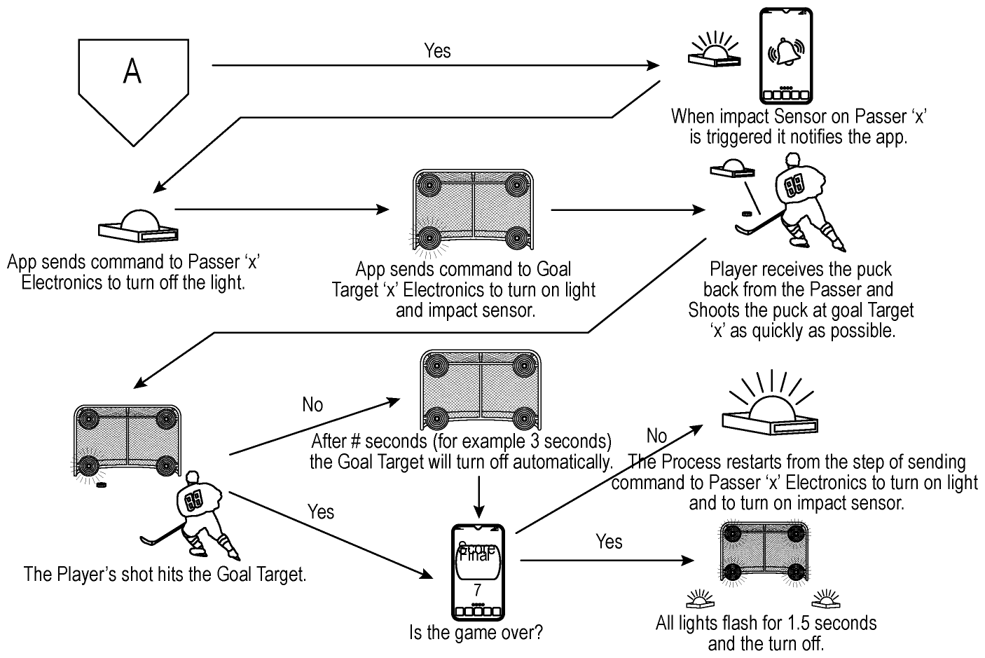

FIG. 2 is a flow diagram illustrating a method of practicing a sports game, using the aforementioned system 100. According to an embodiment, the method of practicing a sports game, using an interactive game virtualization and practicing system 100 is disclosed. Referring to FIG. 2, the method includes the step of launching a software application 106, 304 on the user interface of a user device 103, 305, wherein the software application 106, 304 serves as the control center for the interactive game virtualization and practicing system 100. Further, the player turns on one or more interactive goal targets 101 and one or more interactive passing devices 300. Each of the goal targets 101 and passing devices 300 includes electronic components such as a Bluetooth microcontroller unit (MCU), an LED light 301, one or more sensors 302, a battery and a printed circuit board (PCB). The software application 106, 304 is connected, via Bluetooth, with the goal targets 101 and passing devices 300. The user interface of the software application 106, 304 includes options for selecting game modes, displaying scoring, game results, and configuring the electronics settings. Further, the electronics settings include sensitivity of the one or more sensors 302 and connecting the electronics of the goal targets 101 and passing devices 300 to the software application 106, 304. In one aspect, the electronic components are configured to wirelessly communicate with each other or with the software application 106, 304 via Bluetooth. Thus, the game can be played with or without the software application 106, 304. In one aspect, a game mode is selected by the player on the software application 106, 304. The goal targets 101 and passing devices 300 are segregated into two groups on the user interface of the software application 106, 304 in order to distinguish the goal targets 101 and. The goal targets 101 and passing devices 300 are segregated such that the software application 106, 304 sends commands to respective passing devices 300 and goal targets 101 that need to receive the pass and hit, wherein the commands include turn on and turn off the LED lights 301, turn on user preferred colors, and light flashing patterns. In one specific aspect, the light 301 of one of the passing devices 300 is turned on, via Bluetooth, to illuminate by the software application 106, 304. The method further includes the step of passing the puck 105, 303 to hit the light-illuminating passing device, by the player using a propelling device. Upon the puck 105, 303 hitting the passing device, the one or more sensors 302 recognize the hit and alerts the software application 106, 304 of the hit by triggering a notification to the application via Bluetooth. In various aspects, the one or more sensors 302 includes, but not limited to, impact sensor, infrared sensor, motion sensor, position sensor, proximity sensor, vibration sensor or any other sensor that senses the physical contact of an object. The puck 105, 303 is then rebound 209, by the passing device, to the player. The software application 106, 304 is triggered to turn on the light 301 of one of the goal targets 101 to illuminate. The light-illuminating goal target is shot at by the player. The method further includes the step of determining whether the puck 105, 303 successfully hits the illuminated goal target. The one or more sensors 302 are configured to detect whether the puck 105, 303 hits the goal target 101, wherein the one or more sensors 302 are further calibrated to sense the impact or movement of the puck 105, 303 based on the weight, size, and typical travel speeds of the puck 105, 303. In addition, the sensitivity of the one or more sensors 302 are adjustable to accommodate different players who shoot and pass the puck 105, 303 at different speeds. The light 301 of the goal target 101 is turned off and the score of the player is recorded on the software application 106, 304, if the goal target 101 is hit by the puck 105, 303. The light of the illuminating goal target is turned off, if the goal target 101 is not hit by the puck 105, 303 within preset time. Steps from turning on the light 301 of the passing device to turning off the light 301 of the illuminating goal target are repeated until the puck 105, 303 hits the illuminating goal target a preset number of times. The gaming system 100 as disclosed herein has several advantages including gaining interactive hockey playing experience by the players, simulating the process of passing the puck 105, 303 while improving the passing skills of the players in an interactive manner and improving hand-eye coordination and accuracy in hockey passes for better game performance.

According to another embodiment, a method of practicing a sports game, using an interactive game practicing system is disclosed. The method involves the step of turning on the electronics of one or more passing devices and one or more goal targets. Each of the goal targets and passing devices includes electronic components such as a Bluetooth microcontroller unit (MCU), an LED light, one or more sensors, a battery and a printed circuit board (PCB). In various embodiments, the one or more sensors includes impact sensor, infrared sensor, motion sensor, position sensor, proximity sensor, vibration sensor or any other sensor that senses or predicts the physical contact of an object. Electronic components of the goal targets and passing devices are configured to wirelessly communicate with each other or with the software via Bluetooth.

Further, a player selects one of the electronics to act as the host that other electronics connect to, wherein each of the electronics uses the same firmware and any of the electronics can interchangeably serve as the host or slave when selected or not selected, respectively, by a player. The host electronics is selected by tapping one of the targets. All the other electronics devices, of both the passers and the goal targets, connect to the host electronics, wherein the lights are used to indicate a successful connection with the host.

In an aspect, electronics of passing devices and goal targets are segregated by tapping the electronics of one or more passing devices twice such that the lights of passing devices differentiate from the lights of goal targets. In another aspect, the host electronics is tapped distinctly (for example 3 times in quick succession) to indicate completion of the segregation step, wherein some or all of the electronics illuminates in different colors and/or light patterns, representing different game modes when the segregation step is completed. In one aspect, the goal targets and passing devices are segregated such that the host device's software sends commands to respective passing devices and goal targets that are intended to receive the pass and shot, wherein the commands include turn on and turn off the LED lights, turn on user preferred colors, and light flashing patterns. After the segregation step the lights on each of the targets display either a different color or light pattern, each representing a different game mode. The player taps one of the goal targets to start a specific game mode.

In a specific aspect, the player passes a propelled object, like a puck, using a propelling device, like a hockey stick, to hit the light-illuminating passing device. Further, the method includes the steps of alerting, via Bluetooth, the host electronics of the hit; upon the puck hitting the passing device and then rebounding the puck, by the passing device, to the player. The software of the host electronics is triggered to turn on the light of one of the goal targets to illuminate.

The player then shoots the puck at the light-illuminating goal target using the propelling device. In one aspect, the method includes the step of determining whether the puck successfully hits the illuminated goal target. The one or more sensors are configured to detect or predict whether the puck hits the passer and goal target according to an embodiment of the invention. The one or more sensors are further calibrated to sense the impact or movement of the puck based on the puck weight, size, and typical travel speeds of hitting and passing the puck. The light of the goal target is turned off if the goal target is hit by the puck or if the goal target is not hit by the puck within preset time. Steps from turning on the light of the passing device to turning off the light of the illuminating goal target are repeated until the puck hits the illuminating goal target to preset times.

It will finally be understood that the disclosed embodiments are presently preferred examples of how to make and use the claimed invention, and are intended to be explanatory rather than limiting the scope of the invention as defined by the claims below. Reasonable variations and modifications of the illustrated examples in the foregoing written specification and drawings are possible without departing from the scope of the invention as defined in the claim below. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology. The scope of the invention supported by the above disclosure should accordingly be construed within the scope of what it teaches and suggests to those skilled in the art, and within the scope of any claims that the above disclosure supports. The scope of the invention is accordingly defined by the following claims.

This application is intended to cover any adaptations or variations of the present invention. Therefore, it is manifestly intended that this invention be limited only by the claims and the equivalents thereof.

1. A method of practicing a sports game, using an interactive game virtualization and practicing system, comprising:
launching a software application on the user interface of a user device, wherein the software application serves as the control center for the interactive game virtualization and practicing system;
turning on, by a player, one or more interactive goal targets and one or more interactive passing devices,
wherein each of the goal targets and passing devices includes electronic components such as a Bluetooth microcontroller unit (MCU), an LED light, one or more sensors, a battery and a printed circuit board (PCB);
establishing wireless communication by connecting the electronic components with the software application via Bluetooth MCU;
selecting, by the player, a game mode on the software application;
segregating, on the user interface of the software application, the goal targets and passing devices into two groups in order to distinguish the goal targets and passing devices, wherein the goal targets and passing devices are segregated such that the software application sends commands to respective passing devices and goal targets that are intended to receive the pass and shot;
turning on, by the software application, via Bluetooth MCU, the light of one of the passing devices to illuminate;
passing, by the player, using a propelling device, the puck to hit the light-illuminating passing device,
wherein, upon the puck hitting the passing device:
alerting, via Bluetooth MCU, the software application of the hit by triggering a notification to the software application; and
rebounding the puck, by the passing device, to the player;
triggering the software application to turn on the light of one of the goal targets to illuminate;
shooting, by the player, at the light-illuminating goal target;
determining whether the puck successfully hits the illuminated goal target;
turning off the light of the goal target and recording, in the software application, the score of the player, if the goal target is hit by the puck;
turning off the light of the illuminating goal target, if the goal target is not hit by the puck within preset time; and
repeating steps from turning on the light of the passing device to turning off the light of the illuminating goal target until the puck hits the illuminating goal target to preset times.

2. The method of claim 1, wherein the one or more sensors are configured to detect or predict whether the puck hits the passing device and goal target, and alerts the software application of the hit, via Bluetooth MCU, by triggering the notification to the software application.

3. The method of claim 1, wherein the one or more sensors include impact sensor, infrared sensor, motion sensor, position sensor, proximity sensor, vibration sensor or any other sensor that senses or predicts the physical contact of an object.

4. The method of claim 1, wherein the one or more sensors are calibrated to sense the impact or movement of the puck based on the weight, size, and typical travel speeds of shooting and passing the puck.

5. The method of claim 1, wherein the commands include turn on and turn off the lights, turn on user preferred colors, and light flashing patterns.

6. The method of claim 1, wherein the electronics settings includes sensitivity of the one or more sensors and connecting the electronic components to the software application.

7. An interactive game virtualization and practicing system, comprising:
one or more interactive passing devices;
one or more interactive goal targets;
wherein each of the goal targets and passing devices includes electronic components such as a Bluetooth microcontroller unit (MCU), a light, one or more sensors, a battery and a printed circuit board (PCB);
a support structure, wherein the goal targets are attached to the support structure using a connecting mechanism;
a propelling device, like a hockey stick;
a propelled device, like a hockey puck; and
a software application, wherein the software application serves as the control center for the interactive game virtualization and practicing system;
wherein the system components are configured to perform the method of practicing a sports game, wherein the method comprising:
launching a software application on the user interface of a user device, wherein the user interface of the software application includes options for selecting game modes, displaying scoring, game results, and configuring the electronics settings;
turning on, by a player, one or more interactive goal targets and one or more interactive passing devices;
establishing wireless communication by connecting the electronic components with the software application via Bluetooth MCU;
selecting, by the player, a game mode on the software application;
segregating, on the user interface of the software application, the goal targets and passing devices into two groups in order to distinguish the goal targets and passing devices;
turning on, by the software application, via Bluetooth MCU, the light of one of the passing devices to illuminate;
passing, by the player, using a propelling device, the puck to hit the light-illuminating passing device, wherein, upon the puck hitting the passing device:
alerting, via Bluetooth MCU, the software application of the hit by triggering a notification to the software application; and
rebounding the puck, by the passing device, to the player;
triggering the software application to turn on the light of one of the goal targets to illuminate;
shooting, by the player, at the light-illuminating goal target;
determining whether the puck successfully hits the illuminated goal target;
turning off the light of the goal target and recording, in the software application, the score of the player, if the goal target is hit by the puck;
turning off the light of the illuminating goal target, if the goal target is not hit by the puck within preset time; and
repeating steps from turning on the light of the passing device to turning off the light of the illuminating goal target until the puck hits the illuminating goal target to preset times.

8. The system of claim 7, wherein the one or more sensors include impact sensor, infrared sensor, motion sensor, position sensor, proximity sensor, vibration sensor or any other sensor that senses the physical contact or presence of an object.

9. The system of claim 7, wherein the goal targets and passing devices are segregated such that the software application sends commands to respective passing devices and goal targets that are intended to receive the pass and shot.

10. The system of claim 7, wherein the one or more sensors are configured to detect whether the puck hits the passing devices and goal targets.

11. The system of claim 7, wherein the one or more sensors are calibrated to sense the impact or movement of the puck based on the weight, size, and typical travel speeds of hitting and passing the puck.

12. The system of claim 9, wherein the commands include turn on and turn off the LED lights, turn on user preferred colors, and light flashing patterns.

13. The system of claim 7, wherein the electronics settings includes sensitivity of the one or more sensors and connecting the electronic components of the goal targets and passing devices to the software application.

14. A method of practicing a sports game, using an interactive game practicing system, comprising:
turning on the electronics of one or more passing devices and one or more goal targets, wherein the LED lights turn on when the electronics are turned on,
wherein each of the electronics includes identical firmware and can interchangeably serve as the host or slave when selected (or not) by a player and wherein the each of the electronics includes a Bluetooth microcontroller unit (MCU), the LED light, one or more sensors, a battery and a printed circuit board (PCB);
selecting, by a player, one of the electronics to act as a host electronics that other electronics connect to, wherein the host electronics is selected by tapping one of the targets;
establishing wireless communication by connecting the host electronics with electronics of passing devices and goal targets, wherein, upon connecting, the lights of each of the electronics turn on which indicate a successful connection with the host electronics;
segregating electronics of passing devices and goal targets by tapping the electronics of one or more passing devices twice such that the lights of passing devices differentiate from the lights of goal targets;
tapping the host electronics to indicate completion of segregation step, wherein each of the electronics illuminates in different colors and/or light patterns, representing different game modes when the segregation step is completed;
tapping a specific color of passing device to start playing the game;
passing, by the player, using a propelling device, the puck to hit the light-illuminating passing device,
wherein, upon the puck hitting the passing device:
alerting, via Bluetooth MCU, the host electronics of the hit; and
rebounding the puck, by the passing device, to the player;
triggering the host device's firmware to turn on the light of one of the goal targets to illuminate;
shooting, by the player, at the light-illuminating goal target;
determining whether the puck successfully hits the illuminated goal target;
turning off the light of the goal target if the goal target is hit by the puck;
turning off the light of the illuminating goal target, if the goal target is not hit by the puck within preset time; and
repeating steps from turning on the light of the passing device to turning off the light of the illuminating goal target until the puck hits the illuminating goal target to preset times.

15. The method of claim 14, wherein the one or more sensors include impact sensor, infrared sensor, motion sensor, position sensor, proximity sensor, vibration sensor or any other sensor that senses or predicts the physical contact of an object.

16. The method of claim 14, wherein the goal targets and passing devices are segregated such that the host device's firmware sends commands to respective passing devices and goal targets that are intended to receive the pass and shot.

17. The method of claim 14, wherein the one or more sensors are configured to detect or predict whether the puck hits the passing device and goal target.

18. The method of claim 14, wherein the one or more sensors are calibrated to sense the impact or movement of the puck based on the weight, size, and typical travel speeds of hitting and passing the puck.

19. The method of claim 16, wherein the commands include turn on and turn off the LED lights, turn on user preferred colors, and light flashing patterns.
